(19) United States
(12) Patent Application Publication
(10) Pub. No.: US 2012/0092472 A1
(43) Pub. Date: Apr. 19, 2012

(54) IMAGE PROCESSING DEVICE, METHOD OF CONTROLLING IMAGE PROCESSING DEVICE, AND ENDOSCOPE APPARATUS

(75) Inventor: Keiji HIGUCHI, Tokyo (JP)

(73) Assignee: OLYMPUS CORPORATION, Tokyo (JP)

(21) Appl. No.: 13/273,797

(22) Filed: Oct. 14, 2011

(30) Foreign Application Priority Data
Oct. 15, 2010 (JP) 2010-232931

(51) Int. Cl. H04N 7/18

(52) U.S. Cl. 348/65; 348/E07.085

(57) ABSTRACT

An image processing device includes an image acquisition section that successively acquires a reference image via a successive imaging process performed by an imaging section of an endoscope apparatus, the reference image being an image including an image of an observation target, a state detection section that detects an operation state of the endoscope apparatus, and acquires operation state information that indicates a detection result, and an extraction section that extracts an area including the image of the observation target from the acquired reference image as an extraction area to acquire an extracted image, the extraction section determining a degree of position offset correction on the image of the observation target based on the operation state information acquired by the state detection section, and extracting the extracted image from the reference image using an extraction method corresponding to the determined degree of position offset correction.

Japanese Patent Application No. 2010-232931 filed on Oct. 15, 2010, is hereby incorporated by reference in its entirety.

### BACKGROUND

The present invention relates to an image processing device, a method of controlling an image processing device, an endoscope apparatus, and the like.

An electronic blur correction process, an optical blur correction process, or the like has been widely used as a blur correction process performed on a moving image generated by a consumer video camera or the like.

For example, JP-A-5-49599 discloses a method that detects the motion of the end of the endoscopy scope, and performs a blur correction process based on the detection result.

JP-A-2009-71380 discloses a method that detects the motion amount of the object, and stops the moving image at an appropriate timing by detecting a freeze instruction signal to acquire a still image.

### SUMMARY

According to one aspect of the invention, there is provided an image processing device comprising:

an image acquisition section that successively acquires a reference image via a successive imaging process performed by an imaging section of an endoscope apparatus, the reference image being an image including an image of an observation target;

a state detection section that detects an operation state of the endoscope apparatus, and acquires operation state information that indicates a detection result; and

an extraction section that extracts an area including the image of the observation target from the acquired reference image as an extraction area to acquire an extracted image,

the extraction section determining a degree of position offset correction on the image of the observation target based on the operation state information acquired by the state detection section, and extracting the extracted image from the reference image using an extraction method corresponding to the determined degree of position offset correction.

According to another aspect of the invention, there is provided an endoscope apparatus comprising:

an image processing device; and

an endoscopy scope.

According to another aspect of the invention, there is provided a method of controlling an image processing device, the method comprising:

successively acquiring a reference image via a successive imaging process performed by an imaging section of an endoscope apparatus, the reference image being an image including an image of an observation target;

detecting an operation state of the endoscope apparatus, and acquiring operation state information that indicates a detection result; and

determining a degree of position offset correction on the image of the observation target based on the acquired operation state information when extracting an area including the image of the observation target from the acquired reference image as an extraction area and acquiring an extracted image; and

extracting the extracted image from the reference image using an extraction method corresponding to the determined degree of position offset correction.

According to another aspect of the invention, there is provided an image processing device comprising:

an image acquisition section that successively acquires a reference image via a successive imaging process performed by an imaging section of an endoscope apparatus, the reference image being an image including an image of an observation target;

a setting section that sets a first extraction mode and a second extraction mode when extracting an image including the image of the observation target from the acquired reference image as an extracted image, the first extraction mode being an extraction mode in which a position offset of the image of the observation target included in the extracted image is corrected, and the second extraction mode being an extraction mode in which a position offset of the image of the observation target is not corrected;

a state detection section that detects an operation state of the endoscope apparatus, and acquires operation state information that indicates a detection result; and

an extraction section that selects the first extraction mode or the second extraction mode based on the acquired operation state information, and extracts the extracted image from the reference image using an extraction method corresponding to the selected extraction mode,

the state detection section acquiring information as to whether or not a scope of the endoscope apparatus is used to supply air or water as the operation state information, and

the extraction section selecting the second extraction mode when it has been determined that the scope of the endoscope apparatus is used to supply air or water based on the acquired operation state information.

According to another aspect of the invention, there is provided an image processing device comprising:

an image acquisition section that successively acquires a reference image via a successive imaging process performed by an imaging section of an endoscope apparatus, the reference image being an image including an image of an observation target;

a setting section that sets a first extraction mode and a second extraction mode when extracting an image including the image of the observation target within the reference image from the acquired reference image as an extracted image, the first extraction mode being an extraction mode in which a position offset of the image of the observation target included in the extracted image is corrected, and the second extraction mode being an extraction mode in which a position offset of the image of the observation target is not corrected;

a state detection section that detects an operation state of the endoscope apparatus, and acquires operation state information that indicates a detection result; and

an extraction section that selects the first extraction mode or the second extraction mode based on the acquired operation state information, and extracts the extracted image from the reference image using an extraction method corresponding to the selected extraction mode,

the state detection section acquiring information as to whether or not a scope of the endoscope apparatus is used to treat the observation target as the operation state information, and

the extraction section selecting the second extraction mode when it has been determined that the scope of the endoscope apparatus is used to treat the observation target based on the acquired operation state information.

### BRIEF DESCRIPTION OF THE DRAWINGS

FIG. 1 shows a configuration example of an endoscope apparatus that includes an image processing device according to one embodiment of the invention.

FIG. 2 shows the spectral characteristics of an imaging element.

FIG. 3 shows a configuration example of a rotary filter.

FIG. 4 shows the spectral characteristics of a white light transmission filter.

FIG. 5 shows the spectral characteristics of a narrow-band transmission filter.

FIG. 6 is a view showing the relationship between the zoom magnification and the degree of position offset correction.

FIG. 7 shows an example of a scope of an endoscope apparatus.

FIG. 8 is a view illustrative of a normal position offset correction method.

FIG. 9 is a view illustrative of a reduced position offset correction method.

FIGS. 10A to 10G are views illustrative of an extreme situation that occurs when using a normal position offset correction method.

FIG. 11 is a view showing the relationship between a dial operation and the degree of position offset correction.

FIG. 12 is a view showing the relationship between the air supply volume or the water supply volume and the degree of position offset correction.

FIG. 13 shows another configuration example of an endoscope apparatus that includes an image processing device according to one embodiment of the invention.

FIG. 14 shows yet another configuration example of an endoscope apparatus that includes an image processing device according to one embodiment of the invention.

FIG. 15 shown an example of a display image when an attention area has been detected.

### DESCRIPTION OF EXEMPLARY EMBODIMENTS

The user of an endoscope apparatus may desire to insert the endoscope into a body, roughly observe the object, and observe an attention area (e.g., lesion candidate area) in a magnified state when the user has found the attention area. Several aspects of the invention may provide an image processing device, a method of controlling an image processing device, an endoscope apparatus, and the like that set the degree of position offset correction based on operation state information that indicates the state of the endoscope apparatus to present a moving image with a moderately reduced blur to the user.

Several aspects of the invention may provide an image processing device, a method of controlling an image processing device, an endoscope apparatus, and the like that improve the observation capability and reduce stress imposed on the user by presenting a blurless moving image to the user even in a specific situation (e.g., the scope is moved closer to the attention area).

According to one embodiment of the invention, there is provided an image processing device comprising:

an image acquisition section that successively acquires a reference image via a successive imaging process performed by an imaging section of an endoscope apparatus, the reference image being an image including an image of an observation target;

a state detection section that detects an operation state of the endoscope apparatus, and acquires operation state information that indicates a detection result; and

an extraction section that extracts an area including the image of the observation target from the acquired reference image as an extraction area to acquire an extracted image,

the extraction section determining a degree of position offset correction on the image of the observation target based on the operation state information acquired by the state detection section, and extracting the extracted image from the reference image using an extraction method corresponding to the determined degree of position offset correction. According to another embodiment of the invention, there is provided an endoscope apparatus comprising: the above image processing device; and an endoscopy scope.

According to the image processing device, the degree of position offset correction is determined based on the operation state information, and the extracted image is extracted using an extraction method corresponding to the determined degree of position offset correction. This makes it possible to perform an appropriate position offset correction process corresponding to the operation state (situation).

According to another embodiment of the invention, there is provided a method of controlling an image processing device, the method comprising:

successively acquiring a reference image via a successive imaging process performed by an imaging section of an endoscope apparatus, the reference image being an image including an image of an observation target;

detecting an operation state of the endoscope apparatus, and acquiring operation state information that indicates a detection result;

determining a degree of position offset correction on the image of the observation target based on the acquired operation state information when extracting an area including the image of the observation target from the acquired reference image as an extraction area and acquiring an extracted image: and

extracting the extracted image from the reference image using an extraction method corresponding to the determined degree of position offset correction.

According to another embodiment of the invention, there is provided an image processing device comprising:

an image acquisition section that successively acquires a reference image via a successive imaging process performed by an imaging section of an endoscope apparatus, the reference image being an image including an image of an observation target;

a setting section that sets a first extraction mode and a second extraction mode when extracting an image including the image of the observation target from the acquired reference image as an extracted image, the first extraction mode being an extraction mode in which a position offset of the image of the observation target included in the extracted image is corrected, and the second extraction mode being an extraction mode in which a position offset of the image of the observation target is not corrected;

a state detection section that detects an operation state of the endoscope apparatus, and acquires operation state information that indicates a detection result; and

an extraction section that selects the first extraction mode or the second extraction mode based on the acquired operation state information, and extracts the extracted image from the reference image using an extraction method corresponding to the selected extraction mode,

the state detection section acquiring information as to whether or not a scope of the endoscope apparatus is used to supply air or water as the operation state information, and

the extraction section selecting the second extraction mode when it has been determined that the scope of the endoscope apparatus is used to supply air or water based on the acquired operation state information.

This makes it possible to set the first extraction mode and the second extraction mode, and select an appropriate extraction mode corresponding to the air supply state or the water supply state.

According to another embodiment of the invention, there is provided an image processing device comprising:

an image acquisition section that successively acquires a reference image via a successive imaging process performed by an imaging section of an endoscope apparatus, the reference image being an image including an image of an observation target;

a setting section that sets a first extraction mode and a second extraction mode when extracting an image including the image of the observation target within the reference image from the acquired reference image as an extracted image, the first extraction mode being an extraction mode in which a position offset of the image of the observation target included in the extracted image is corrected, and the second extraction mode being an extraction mode in which a position offset of the image of the observation target is not corrected;

a state detection section that detects an operation state of the endoscope apparatus, and acquires operation state information that indicates a detection result; and

an extraction section that selects the first extraction mode or the second extraction mode based on the acquired operation state information, and extracts the extracted image from the reference image using an extraction method corresponding to the selected extraction mode,

the state detection section acquiring information as to whether or not a scope of the endoscope apparatus is used to treat the observation target as the operation state information, and

the extraction section selecting the second extraction mode when it has been determined that the scope of the endoscope apparatus is used to treat the observation target based on the acquired operation state information.

This makes it possible to set the first extraction mode and the second extraction mode, and select an appropriate extraction mode corresponding to the state of treatment on the observation target.

Exemplary embodiments of the invention are described below. Note that the following exemplary embodiments do not in any way limit the scope of the invention laid out in the claims. Note also that all of the elements of the following exemplary embodiments should not necessarily be taken as essential elements of the invention.

1. Method

1.1 Configuration Example of Endoscope Apparatus

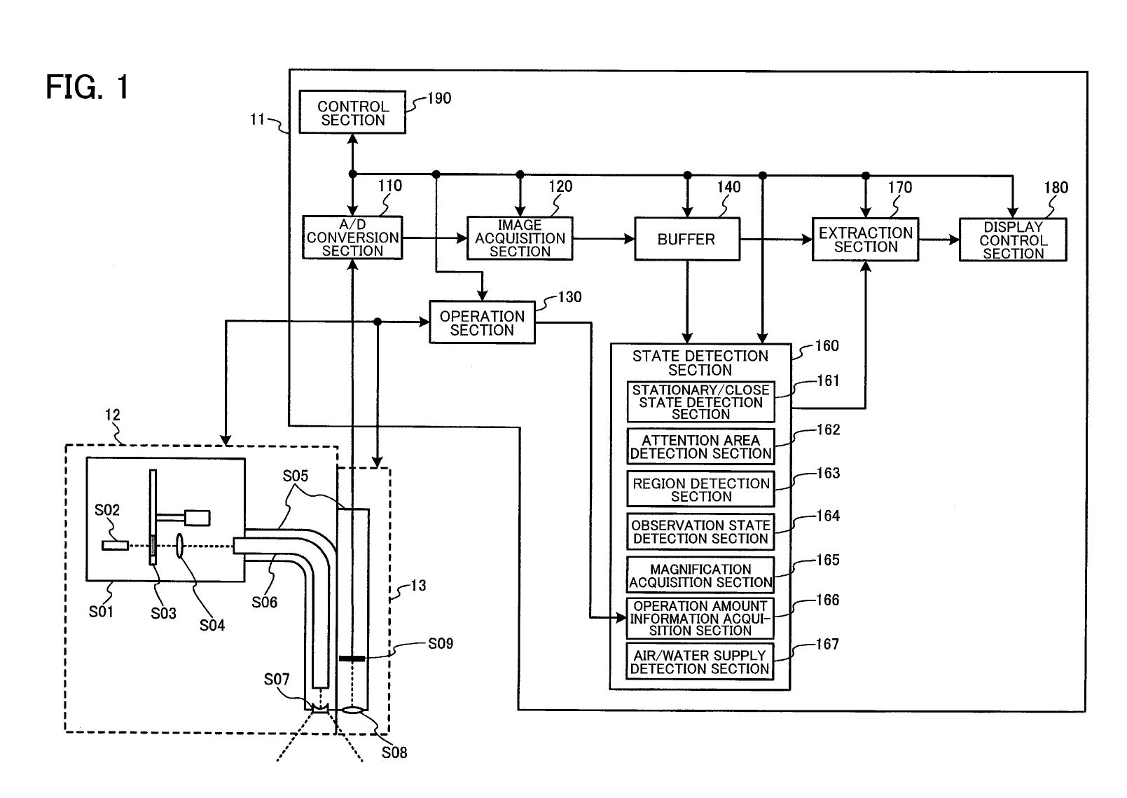

FIG. 1 shows a configuration example of an endoscope apparatus that includes an image processing device according to one embodiment of the invention. The endoscope apparatus includes an illumination section 12, an imaging section 13, and a processing section 11. Note that the configuration of the endoscope apparatus is not limited thereto. Various modifications may be made, such as omitting some of these elements.

The illumination section 12 includes a light source device S01, a covering S05, a light guide fiber S06, and an illumination optical system S07. The light source device S01 includes a white light source S02, a rotary filter S03, and a condenser lens S04. Note that the configuration of the illumination section 12 is not limited thereto. Various modifications may be made, such as omitting some of these elements.

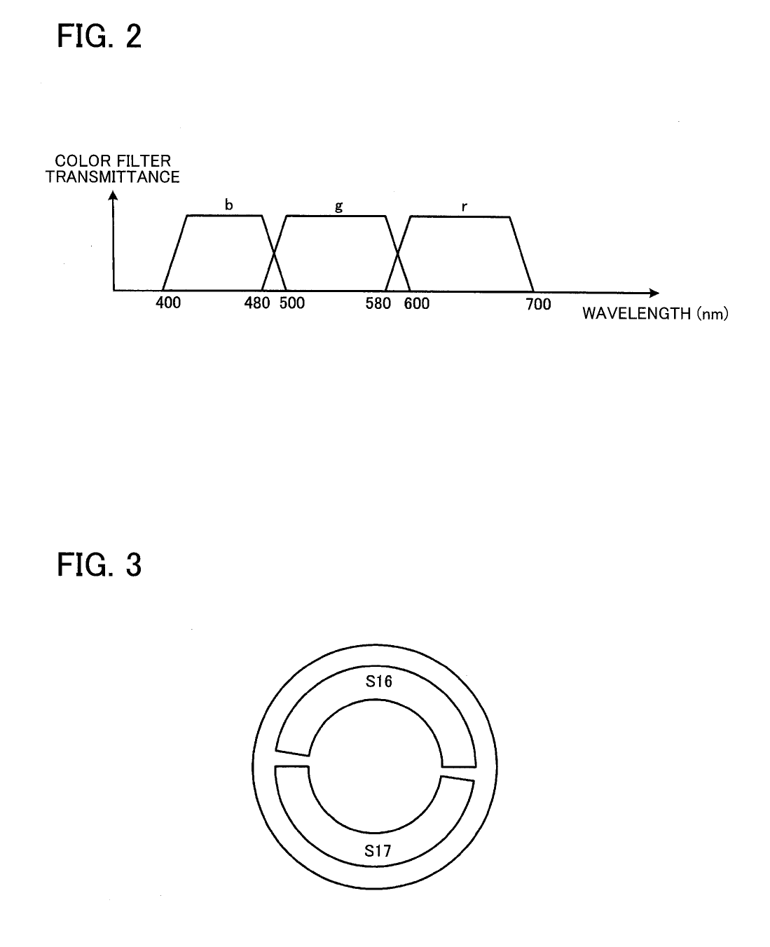

The imaging section 13 includes the covering S05, a condenser lens S08, and an imaging element S09. The imaging element S09 has a Bayer color filter array. Color filters R, G, and B of the imaging element S09 have spectral characteristics shown in FIG. 2, for example.

The imaging element may utilize an imaging method other than that using an RGB Bayer array. For example, the imaging element may receive complementary-color image.

The imaging element is configured to capture a normal light image and a special light image almost simultaneously. Note that the imaging element may be configured to capture only a normal light image, or an R imaging element, a G imaging element, and a B imaging element may be provided to capture an RGB image.

The processing section 11 includes an A/D conversion section 110, an image acquisition section 120, an operation section 130, a buffer 140, a state detection section 160, an extraction section 170, and a display control section 180. Note that the configuration of the processing section 11 is not limited thereto. Various modifications may be made, such as omitting some of these elements.

The A/D conversion section 110 that receives an analog signal from the imaging element S09 is connected to the image acquisition section 120. The image acquisition section 120 is connected to the buffer 140. The operation section 130 is connected to the illumination section 12, the imaging section 13, and an operation amount information acquisition section 166 (described later) included in the state detection section 160. The buffer 140 is connected to the state detection section 160 and the extraction section 170. The extraction section 170 is connected to the display control section 180. The state detection section 160 is connected to the extraction section 170.

The A/D conversion section 110 converts the analog signal output from the imaging element S09 into a digital signal. The image acquisition section 120 acquires the digital image signal output from the A/D conversion section 110 as a reference image. The operation section 130 includes an interface (e.g., button) operated by the user. The operation section 130 also includes a scope operation dial and the like. The buffer 140 receives and stores the reference image output from the image acquisition section.

The state detection section 160 detects the operation state of the endoscope apparatus, and acquires operation state information that indicates the detection result. The state detection section 160 includes a stationary/close state detection section 161, an attention area detection section 162, a region detection section 163, an observation state detection section 164, a magnification acquisition section 165, the operation amount information acquisition section 166, and an air/water supply detection section 167. Note that the configuration of the state detection section 160 is not limited thereto. Various modifications may be made, such as omitting some of these elements. The state detection section 160 need not necessarily include all of the above sections. It suffices that the state detection section 160 include at least one of the above sections.

The stationary/close state detection section 161 detects the motion of an insertion section (scope) of the endoscope apparatus. Specifically, the stationary/close state detection section 161 detects whether or not the insertion section of the endoscope apparatus is stationary, or detects whether or not the insertion section of the endoscope apparatus moves closer to the object. The attention area detection section 162 detects an attention area (i.e., an area that should be paid attention to) from the acquired reference image. The details of the attention area are described later. The region detection section 163 detects an in vivo region into which the insertion section of the endoscope apparatus is inserted. The observation state detection section 164 detects the observation state of the endoscope apparatus. Specifically, when the endoscope apparatus is provided with a normal observation mode and a magnifying observation mode, the observation state detection section 164 detects whether the endoscope apparatus is currently set to the normal observation mode or the magnifying observation mode. The magnification acquisition section 165 acquires the imaging magnification of the imaging section 13. The operation amount information acquisition section 166 acquires operation amount information about the operation section 130. For example, the operation amount information acquisition section 166 acquires information about the degree by which the dial included in the operation section 130 has been turned. The air/water supply detection section 167 detects whether or not an air supply process or a water supply process has been performed by the endoscope apparatus. The air/water supply detection section 167 may detect the air supply volume and the water supply volume.

The extraction section 170 determines the degree of position offset correction on an image of the observation target based on the operation state information detected (acquired) by the state acquisition section 160, and extracts an extracted image from the reference image using an extraction method corresponding to the determined degree of position offset correction. The term “extracted image” refers to an image obtained by extracting an area including an image of the observation target from the reference image.

The display control section 180 performs a control process that displays the extracted image. The display control section 180 may perform a control process that displays degree-of-correction information that indicates the degree of position offset correction determined by the extraction section 170.

1.2 Process Flow

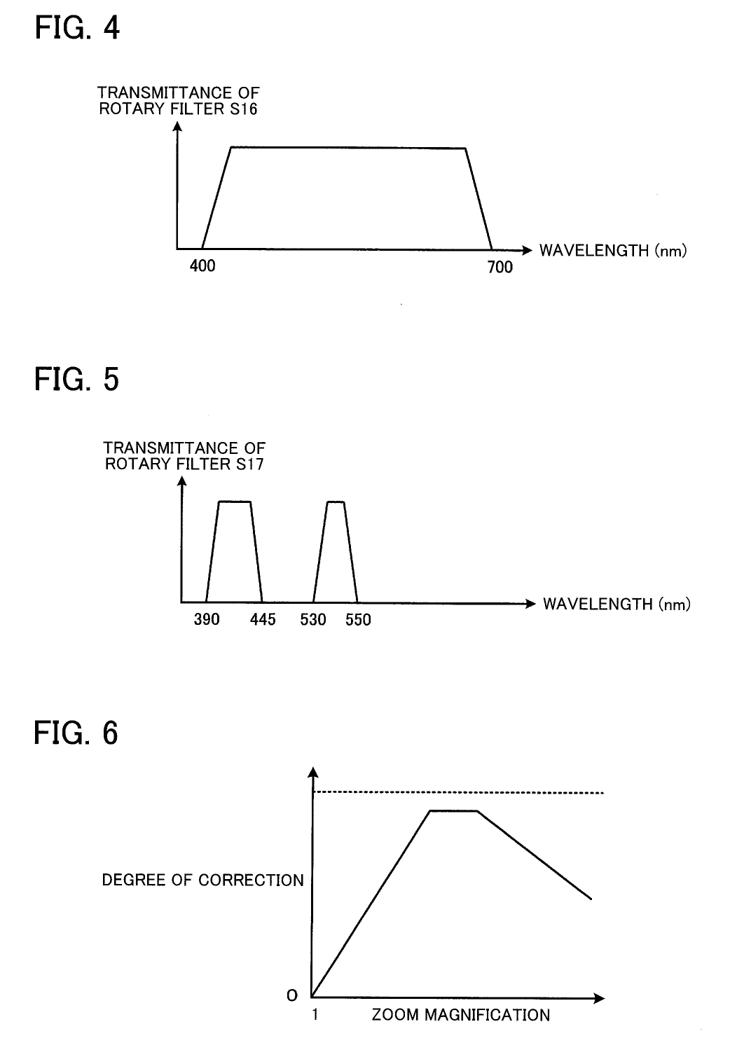

The flow of the process is described below. First, the white light source S02 emits white light. As shown in FIG. 3, the rotary filter S03 includes a white light transmission filter S16 and a narrow-band transmission filter S17. The white light transmission filter S16 has spectral characteristics shown in FIG. 4, and the narrow-band transmission filter S17 has spectral characteristics shown in FIG. 5, for example.

The white light emitted from the white light source S02 alternately passes through the white light transmission filter S16 and the narrow-band transmission filter S17 of the rotary filter S03. Therefore, the white light that has passed through the white light transmission filter S16 and special light that has passed through the narrow-band transmission filter S17 are alternately focused by (alternately reach) the condenser lens S04. The focused white light or special light passes through the light guide fiber S06, and is applied to the object from the illumination optical system S07.

Reflected light from the object is focused by the condenser lens S08, reaches the imaging element S09 in which RGB imaging elements are disposed in a Bayer array, and is converted into an analog signal via photoelectric conversion. The analog signal is transmitted to the A/D conversion section 110.

The analog signal acquired by applying white light is converted into a digital signal by the A/D conversion section 110. The digital signal is output to the image acquisition section 120, and stored as a normal light image. The analog signal acquired by applying special light is converted into a digital signal by the A/D conversion section 110. The digital signal is output to the image acquisition section 120, and stored as a special light image. The special light image may be used for the attention area detection process performed by the attention area detection section 162. The special light image may not be used when the attention area detection section 162 is not provided, or performs the attention area detection process based on the normal light image. In this case, it is unnecessary to acquire the special light image, and the rotary filter S03 can be omitted.

The image acquired by the image acquisition section 120 is referred to as “reference image”. The reference image has an area having a size larger than that of the final output image. The reference image acquired by the image acquisition section 120 is stored in the buffer 140. The extraction section 170 determines the degree of position offset correction based on the operation state information acquired by the state acquisition section 160, extracts an area that reduces a blur during sequential observation as an extracted image, and transmits the extracted image to the display control section 180. This makes it possible to obtain a moving image with a reduced blur. The moving image transmitted to the display control section 180 is transmitted to a display device (e.g., monitor), and presented (displayed) to the user.

1.3 Determination of Degree of Position Offset Correction Corresponding to Operation State Information

The above process makes it possible to present a moving image subjected to the blur correction process to the user. In one embodiment of the invention, the extraction process (i.e., determination of the degree of position offset correction) performed by the extraction section 170 is controlled using the operation state information output from the state detection section 160. The extraction section 170 receives information from at least one of the stationary/close state detection section 161, the attention area detection section 162, the region detection section 163, the observation state detection section 164, the magnification acquisition section 165, the operation amount information acquisition section 166, and the air/water supply detection sections 167 included in the state detection section 160, and controls the degree of position offset correction.

A method that determines the degree of position offset correction based on the information output from each section is described in detail below.

1.3.1 Determination of Degree of Position Offset Correction Based on Stationary/Close State Detection

The stationary/close state detection section 161 determines whether the scope (insertion section) of the endoscope apparatus moves closer to the object, moves away from the object, or is stationary. A matching process based on an image or the like may be used for the determination process. Specifically, whether or not the scope moves closer to the object is determined by recognizing the edge shape of the observation target within the captured image using an edge extraction process or the like, and determining whether the size of the recognized edge shape has increased or decreased within an image captured in the subsequent frame in time series, for example. Note that whether or not the scope moves closer to the object may be determined by a method other than image processing. Various methods (e.g., a method that determines a change in distance between the insertion section and the object using a ranging sensor (e.g., infrared active sensor) may also be used.

When the scope moves closer to the object, it is considered that the user aims to closely observe a specific area of the object using the scope. Therefore, the extraction section 170 increases the degree of position offset correction. When the scope moves away from the object, it is considered that the user has completed close observation. Therefore, the extraction section 170 decreases the degree of position offset correction. When the scope is stationary, it is considered that the user closely observes a specific area. Therefore, the extraction section 170 increases the degree of position offset correction.

1.3.2 Determination of Degree of Position Offset Correction Based on Attention Area Information Output from Attention Area Detection Section

The attention area detection section 162 detects the attention area information (i.e., information about an attention area) by performing a known area detection process (e.g., lesion detection process). When an attention area (lesion area) has been detected within the image, the user normally desires to carefully observe the attention area. Therefore, the extraction section 170 increases the degree of position offset correction. When a lesion or the like has not been detected within the image, the user normally need not carefully observe the image. Therefore, the extraction section 170 decreases the degree of position offset correction (e.g., disables position offset correction).

The operation section 130 may further include an area detection button. In this case, when the user has pressed the area detection button, the attention area detection section 162 may extract an area including the center of the screen as the attention area, and the extraction section 170 may perform position offset correction so that the extracted area is positioned at the center. It is necessary to recognize the extracted area in order to perform the blur correction process so that the extracted area is positioned at the center. For example, the extracted area may be recognized by an edge extraction process. Note that the extracted area may be recognized by a process other than the edge extraction process.

1.3.3 Determination of Degree of Position Offset Correction Based on Region Detection

The region detection section 163 may determine the region where the scope is positioned, and the degree of position offset correction may be determined based on the region detection result. The in vivo region (e.g., duodenum or colon) where the scope is positioned is determined by a known recognition algorithm (e.g., template matching), for example. The organ where the scope is positioned may be determined by a change in feature quantity of each pixel of the reference image determined by a known scene change recognition algorithm.

For example, when the region where the scope is positioned is the gullet, the object always makes a motion (pulsates) since the object is positioned near the heart. Therefore, the attention area may not come within the range due to a large motion when performing an electronic blur correction process, so that an appropriate position offset correction may not be implemented. An error can be prevented by decreasing the degree of position offset correction when the scope is positioned in such an organ.

1.3.4 Determination of Degree of Position Offset Correction Based on Observation State

An endoscope apparatus developed in recent years may implement a magnifying observation mode at a high magnification (magnification: 100, for example) in addition to a normal observation mode. Since the object is observed at a high magnification in the magnifying observation mode, it is likely that the extracted area does not come within the reference image. Therefore, the degree of position offset correction is decreased in the magnifying observation mode.

Whether or not the observation mode is the magnifying observation mode may be determined using operation information output from the operation section 130, or may be determined using magnification information acquired by the magnification acquisition section 165. For example, when the operation section 130 includes a switch button used to switch the observation mode between the magnifying observation mode and another observation mode, the operation amount information acquisition section 166 acquires information about whether or note the user has pressed the switch button, and the observation state detection section 164 detects the observation state based on the acquired information. When determining whether or not the observation mode is the magnifying observation mode based on the magnification, the observation state detection section 164 may detect whether or not the magnification of the imaging section 13 is set to the magnification corresponding to the magnifying observation mode using the magnification information acquired by the magnification acquisition section 165.

1.3.5 Determination of Degree of Position Offset Correction Based on Magnification Information Output from Magnification Acquisition Section

The magnification acquisition section 165 acquires the imaging magnification of the imaging section 13 as the magnification information. When the imaging magnification indicated by the magnification information is smaller than a given threshold value, it is considered that the user aims to closely observe the object by utilizing magnifying observation. Therefore, the extraction section 170 increases the degree of position offset correction as the magnification increases (see FIG. 6). When the imaging magnification indicated by the magnification information is larger than the given threshold value, it is considered that the user aims to closely observe a specific area. However, since the effect of a blur increases due to a high magnification, it is likely that the extracted area does not come within the reference image. Therefore, the degree of position offset correction is decreased as the magnification increases (see FIG. 6).

1.3.6 Determination of Degree of Position Offset Correction Based on Operation Amount Information Output from Operation Section

The operation section 130 acquires the operation amount information (i.e., information about an operation performed by the user), and transmits the operation amount information to the extraction section 170. The extraction section 170 determines the degree of position offset correction corresponding to the operation amount information.

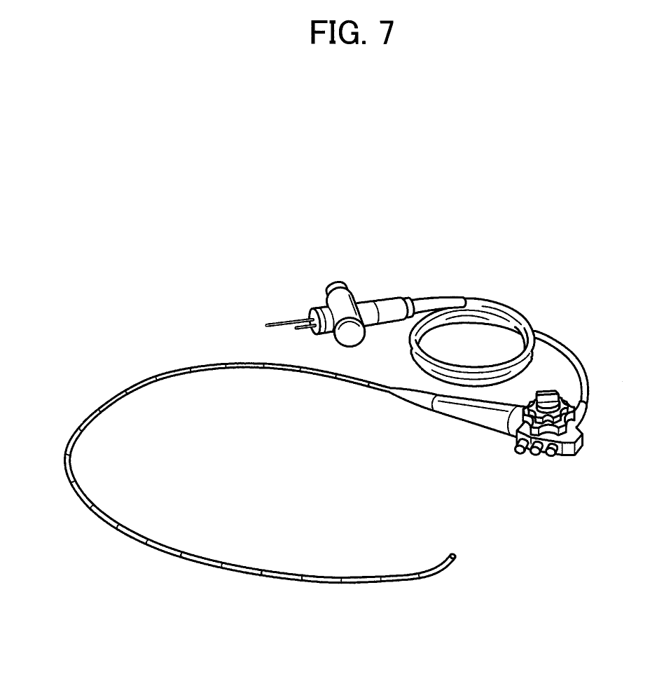

As shown in FIG. 7, a dial that is linked to the motion of the end of the scope of the endoscope is disposed around the scope, for example. When the user has operated the dial, the operation section 130 transmits the operation amount information corresponding to the operation performed on the dial by the user to the extraction section 170. The extraction section 170 adjusts the degree of position offset correction corresponding to the operation performed on the dial (i.e., the motion of the dial). When the amount of operation performed on the dial is larger than a given threshold value, the extraction section 170 decreases the degree of position offset correction (i.e., it is considered that the user has desired to change the field of view rather than performing the blur correction process when the amount of operation performed on the dial is large). It may be difficult to follow the object and apply the electronic blur correction process when the amount of operation performed on the dial is large. The blur correction process is not performed when it is impossible to follow the object.

1.3.7 Determination of Degree of Position Offset Correction Based on Air Supply/Water Supply Information

The air/water supply detection section 167 detects the air supply process or the water supply process performed by the endoscope apparatus. Specifically, the air/water supply detection section 167 detects the air supply volume or the water supply volume. The air supply process (i.e., a process that supplies (feeds) air) is used to expand a tubular region, for example. The water supply process (i.e., a process that supplies (feeds) water) is used to wash away a residue that remains at the observation position, for example.

When the air supply process or the water supply process is performed by the endoscope apparatus, it is considered that the doctor merely aims to supply air or water, and does not observe the object or perform diagnosis until the air supply process or the water supply process ends. Moreover, it is difficult to perform an efficient position offset correction when the object vibrates due to the air supply process, or water flows over the object due to the water supply process. Therefore, the degree of position offset correction is decreased when the air/water supply detection section 167 has determined that the air supply volume or the water supply volume is larger than a given threshold value.

1.4 Normal Electronic Position Offset Correction and Reduced Position Offset Correction

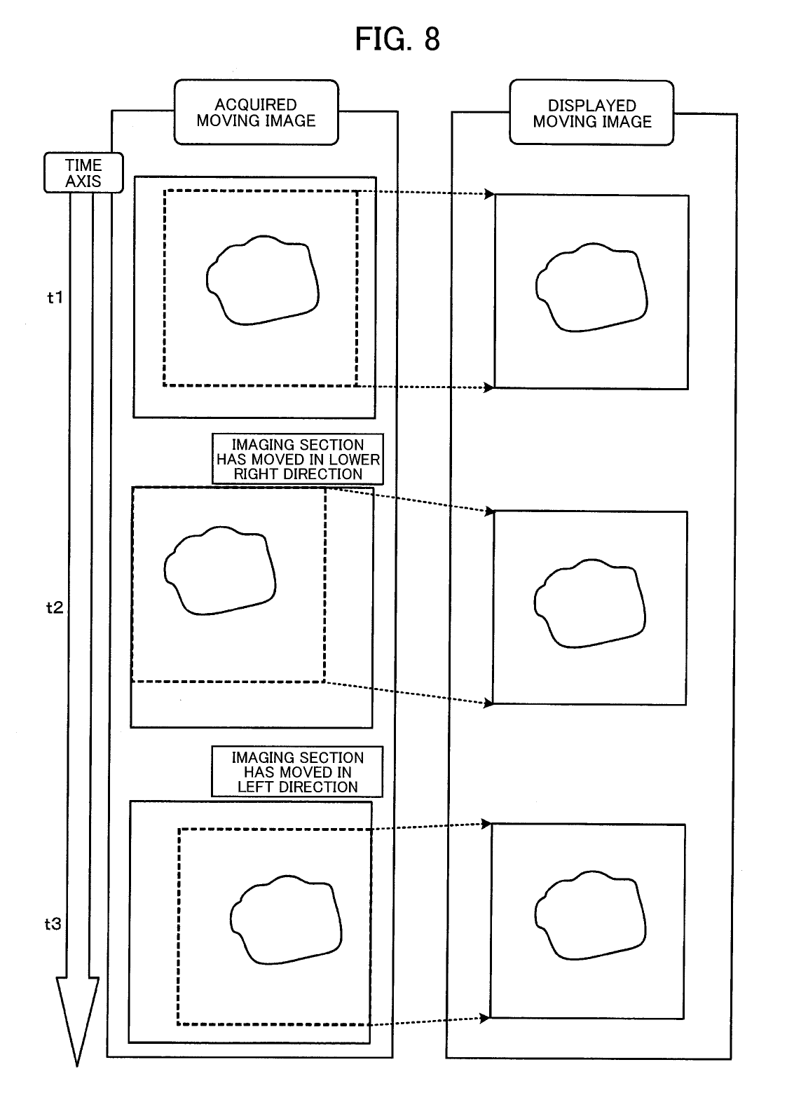

A normal electronic position offset correction process is described below with reference to FIG. 8. In FIG. 8, the vertical axis indicates a time axis, and each left image is an image (reference image) that is acquired by the image acquisition section 120, and stored in the buffer 140. Each right image that is obtained by extracting an area smaller than the reference image from the reference image is an image (extracted image) presented to the user. An area enclosed by a line within each image is the attention area.

The electronic position offset correction process extracts an area from the reference image so that the attention area is necessarily located at a specific position within the extracted image. In the example shown in FIG. 8, the center position within the extracted image is used as the specific position. Note that the specific position is not limited thereto.

An area is extracted at a time t1 so that the attention area is located at the specific position (center position) to obtain an extracted image. An extracted image in which the attention area is displayed at the specific position can thus be acquired. An area is similarly extracted at a time t2 so that the attention area is located at the specific position (center position) to obtain an extracted image. In the example shown in FIG. 8, the object has moved in the upper left direction at the time t2 since the imaging section 13 has moved in the lower right direction. Therefore, an area that is displaced in the upper left direction from the area extracted at the time t1 is extracted at the time t2. Therefore, an image in which the attention area is located at the specific position can also be displayed at the time t2. Accordingly, the attention area is displayed at an identical position within the images extracted at the times t1 and t2.

In the example shown in FIG. 8, the object has moved in the right direction at a time t3 since the imaging section 13 has moved in the left direction. Therefore, an area that is displaced in the right direction from the area extracted at the time t2 is extracted at the time t3. Therefore, an image (extracted image) in which the attention area is located at the position can also be displayed at the time t3. This makes it possible to present a moving image that is blurless with the passage of time (in time series) to the user.

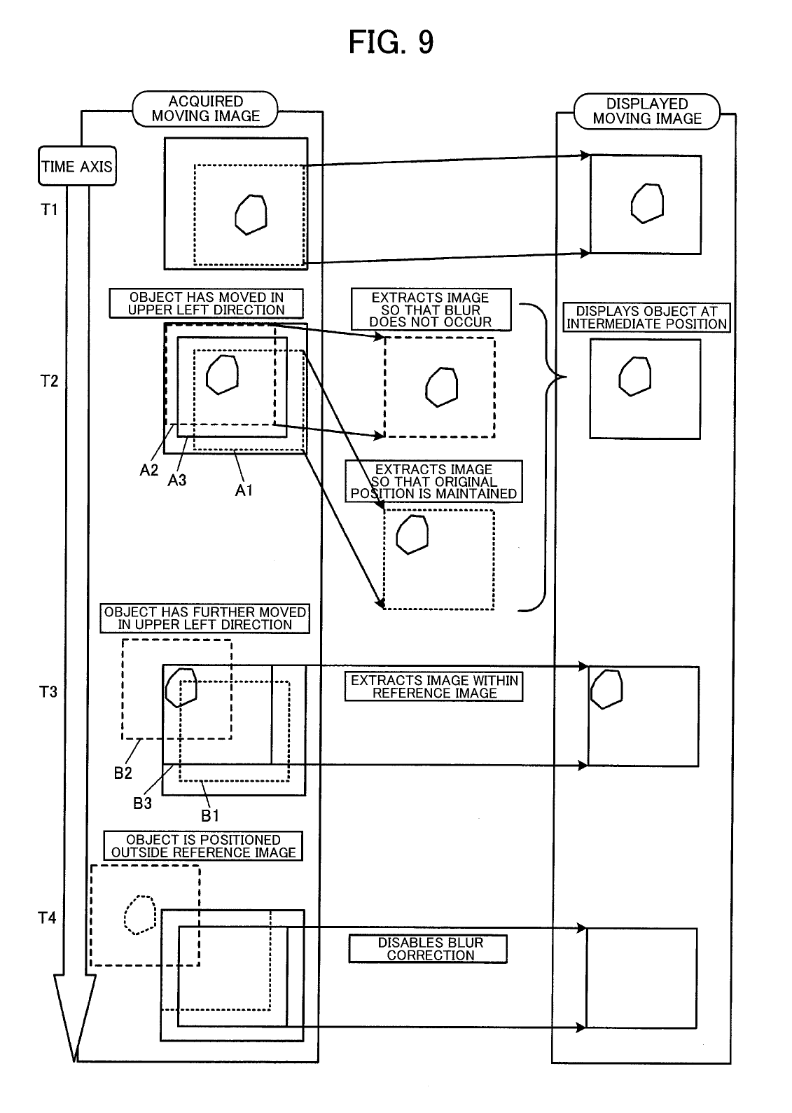

A reduced position offset correction process according to one embodiment of the invention is described below with reference to FIG. 9. In FIG. 9, the vertical axis indicates a time axis, each left image is a reference image, and each right image is an extracted image. An area is extracted at a time T1 so that the attention area is located at a specific position within the extracted image in the same manner as in the normal electronic position offset correction process.

In the example shown in FIG. 9, the object has moved in the upper left direction at a time T2. When the position offset correction process is not performed (i.e., a blurred image is acquired), an area A1 located at the same position as that of the area extracted at the time T1 is extracted. When the area A1 has been extracted, a change in the position of the attention area within the reference image is directly reflected in the extracted image. When the normal electronic position offset correction process is performed (i.e., a blurless image is acquired), an area A2 shown in FIG. 9 is extracted. It is possible to acquire an extracted image without a position offset by extracting the area A2.

The reduced position offset correction process according to one embodiment of the invention extracts an area A3 that is intermediate between the areas A1 and A2. In this case, an extracted image with a position offset is acquired. However, the position offset of the attention area within the extracted image can be reduced as compared with the position offset of the attention area within the reference image.

The attention area is positioned near the edge of the reference image at a time T3. In this case, an area B1 corresponding to the area A1 and an area B2 corresponding to the area A2 are set, and an area that is intermediate between the areas B1 and B2 is extracted. However, it is important to carefully set the position of the area B3. Specifically, since only the image information corresponding to the size of the reference image is acquired (i.e., the image information about an area outside the reference image is not acquired), it is not desirable that the extraction area be set to be partially positioned outside the reference image. Therefore, the area B3 is set within the reference image. In the example shown in FIG. 9, the area B3 is set at a position close to that of the area B1 as compared with the area B2.

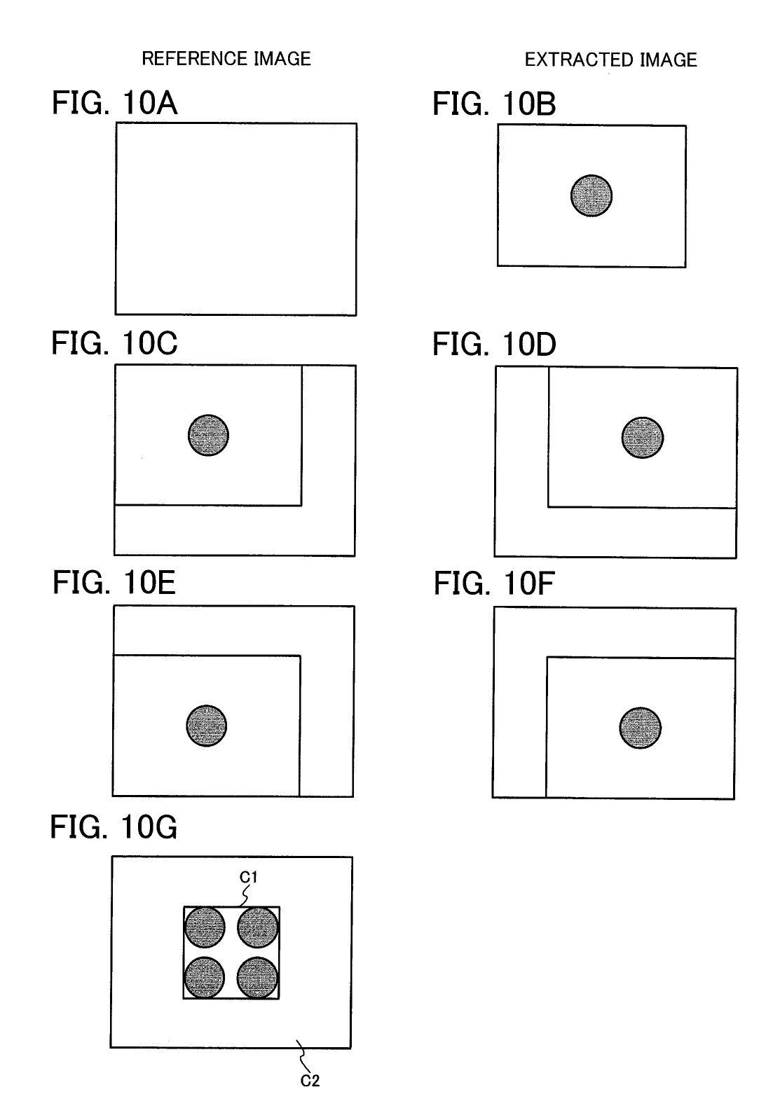

Advantages obtained by performing the reduced position offset correction process are described below. When performing the normal position offset correction process (i.e., a process that eliminates a blur), it is necessary to extract an area so that the attention area is located at a specific position within the extracted image. Therefore, when the reference image has a size shown in FIG. 10A, and the extracted image and the attention area have a size shown in FIG. 10B, the upper left limit position, the upper right limit position, the lower left limit position, and the lower right limit position of the attention area (or the extraction area) that allow the position offset correction process are as shown in FIGS. 10C to 10F. When the attention area has moved beyond the limit positions shown in FIGS. 10C to 10F, the extraction area is partially positioned outside the reference image. Therefore, the moving range of the attention area within the reference image that allows the position offset correction process is limited to an area C1 shown in FIG. 10G. Specifically, when an area within the reference image other than the area C1 is referred to as C2, the position offset correction process can be performed when the attention area is positioned in the area C1, whereas the position offset correction process cannot be performed when the attention area is positioned in the area C2. This means that the normal electronic position offset correction process cannot be performed depending on the position of the attention area (i.e., the position offset correction process goes to extremes).

On the other hand, the reduced position offset correction process can be performed as long as the attention area is positioned within the reference image regardless of the areas C1 and C2. Since a position offset occurs to some extent within the extracted image when using the reduced position offset correction process, a blurless image cannot be provided differing from the case of using the normal position offset correction process. However, the reduced position offset correction process can reduce a position offset (amount of position offset) as compared with the case where the position offset correction process is not performed, and can maintain such an effect even if the attention area has moved to a position near the edge of the reference image.

Specifically, a stepwise change occurs (i.e., the attention area is stationary within a narrow range or moves at a high speed) when performing the normal position offset correction process, whereas the attention area moves within a wide range at a low speed when performing the reduced position offset correction process. The terms “narrow range” and “wide range” used herein refer to the moving range of the attention area that allows the position offset correction process.

When applying the method according to one embodiment of the invention to an endoscope apparatus, the user (doctor) closely observes the attention area, and performs diagnosis or takes appropriate measures. In this case, it is considered to be preferable that a change in the position of the attention area within the image be small even if a blur occurs to some extent rather than a case where the position of the attention area within the image changes to a large extent. The object (in vivo tissue) may not be stationary due to pulsation and the like. Therefore, the position of the attention area within the image may change frequently. In this case, when a change in the position of the attention area within the image occurs so that the attention area is positioned outside the area C1 shown in FIG. 10G, the reduced position offset correction process is advantageous over the normal position offset correction process.

A transition may also occur from a state in which the position offset correction process is appropriately performed to a state in which the attention area is positioned outside the reference image due to a sudden change. In this case, the attention area that has been located (stationary) at a specific position within the extracted image becomes unobservable (i.e., disappears from the screen) when using the normal position offset correction process. Therefore, since the moving direction of the attention area cannot be determined, it is very difficult to find the missing attention area. On the other hand, since the reduced position offset correction process allows a blur to occur to some extent, the moving direction of the attention area can be roughly determined (the moving direction of the attention area may be determined by the user, or may be determined by the system). Therefore, since the moving direction of the attention area can be determined even if the attention area has disappeared from the reference image, the attention area can be easily found again.

In the example shown in FIG. 10G, the area C1 can be increased when the area of the attention area within the extracted image is large (i.e., the area of the attention area is increased). This suppresses a stepwise change between the areas C1 and C2. In such a case, however, a sudden transition may occur from a state in which a blurless image is provided (area C1) to a state in which the attention area is positioned outside the reference image (i.e., the attention area cannot be observed) when using the normal position offset correction process. It is likely that the attention area is positioned outside the reference image and is missed during high-magnification observation. Therefore, the minor blur correction process has the above advantages even if the area of the attention area within the image is increased.

2. Specific Exemplary Embodiments

Specific exemplary embodiments that take account of the actual diagnosis/observation process are described below.

2.1 Lower Gastrointestinal Endoscope

An exemplary embodiment of a lower gastrointestinal endoscope that is inserted through the anus and used to observe the large intestine and the like is described below. Note that the lower gastrointestinal endoscope is completely inserted into the body, and the large intestine and the like are observed while withdrawing the lower gastrointestinal endoscope.

The scope of the endoscope includes the elements provided inside the covering S05 shown in FIG. 1. Note that the illumination optical system S07 and the condenser lens S08 are provided at the end of the scope. An image is acquired by the image acquisition section 120 via the imaging section 13 and the A/D conversion section 110 when inserting the endoscope.

The endoscope is inserted through the anus when starting the diagnosis/observation process. The endoscope is inserted as deep as possible (the large intestine and the like are observed while withdrawing the endoscope). This makes it possible to easily specify the in vivo observation position. Specifically, since the region to be reached by inserting the endoscope can be determined (e.g., descending colon: L1 to L2 cm, transverse colon: L2 to L3 cm), the region (and an approximate position of the region) that is being observed can be determined based on the length of the area of the endoscope that has been withdrawn. Since the insertion operation merely aims to completely insert the endoscope (i.e., close observation is not performed), the blur correction process is unnecessary. Therefore, the extraction section 170 decreases the degree of position offset correction (e.g., disables position offset correction) simultaneously with a scope insertion operation or a dial operation performed by the user.

When the endoscope has been completely inserted, the large intestine and the like are observed while withdrawing the endoscope. In this case, it is considered that the user observes a wide area in order to search a lesion area or the like. The blur correction process is unnecessary when searching an attention area while increasing the field of view. Therefore, the extraction section 170 decreases the degree of position offset correction simultaneously with an endoscope withdrawing operation performed by the user.

The attention area detection section 162 performs the attention area detection process during wide-area observation. When the attention area detection section 162 has detected an attention area, it is desirable to present a stationary image so that the user can carefully observe the detected area. Therefore, the extraction section 170 increases the degree of position offset correction when the attention area has been detected by the attention area detection section 162. When an attention area has not been detected, the extraction section 170 decreases the degree of position offset correction since the position offset correction process is unnecessary. Specifically, the position offset correction process is controlled corresponding to the detection result of the attention area detection section 162.

When the user has found an area that draws attention, the user normally stops the insertion operation or the dial operation in order to closely observe the area. Therefore, it is necessary to present a stationary image with a reduced blur to the user. The extraction section 170 increases the degree of position offset correction when the user has suspended the insertion operation or the dial operation for a given time.

The user may move the end of the scope closer to a certain area in order to observe the area in a state in which the area is displayed in a close-up state. In this case, the stationary/close state detection section 161 included in the state detection section 160 compares the edge shape of an image captured in the preceding frame with the edge shape of an image captured in the current frame (the edge shape is detected by an edge detection process or the like), and determines that the end of the scope has moved closer to the area when the size of the edge shape has increased. The extraction section 170 then increases the degree of position offset correction so that a stationary moving image is presented to the user who is considered to intend to closely observe a specific area.

A residue may remain at the observation position when observing an in vivo tissue. Since such a residue hinders observation, it is considered that the user washes away the residue by supplying water. Since an image acquired when supplying water changes to a large extent, it is difficult to implement the blur correction process. Since the water supply operation merely aims to wash away the residue, the blur correction process is unnecessary. Therefore, the extraction section 170 decreases the degree of position offset correction when the water supply operation has been detected by the air/water supply detection section 167.

Note that the air/water supply detection section 167 may perform the detection process by acquiring the operation state of the operation section 130. When the user has pressed a water supply button (not shown) included in the operation section 130, water supplied from a water supply tank S14 is discharged from the end of the scope via a water supply tube S15. When the user has pressed the water supply button again, discharge of water is stopped. Specifically, the operation information about the operation section 130 is acquired by the operation amount information acquisition section 166 or the like, and the air/water supply detection section 167 detects that the air supply process or the water supply process has been performed based on the acquired information. A sensor may be provided at the end of the water supply tube S15, and information as to whether or not water is supplied may be acquired by monitoring whether or not water is discharged, or monitoring the quantity of water that remains in the water supply tank S14.

2.2 Upper Gastrointestinal Endoscope

An exemplary embodiment of an upper gastrointestinal endoscope that is inserted through the mouth or nose and used to observe the gullet, stomach, and the like is described below.

The endoscope is inserted through the mouth (nose) when starting the observation process. The blur correction process is unnecessary when inserting the endoscope. Therefore, the extraction section 170 decreases the degree of position offset correction simultaneously with the scope insertion operation or the dial operation performed by the user using the operation section 130.

The insertion speed may be determined based on the insertion length per unit time by acquiring insertion length information using the operation amount information acquisition section 166 included in the state detection section 160, for example. When the insertion speed is higher than a given threshold value, it is considered that the insertion operation is in an initial stage (i.e., a stage in which the endoscope is inserted rapidly) (i.e., the endoscope is not inserted for close observation).

The end of the scope reaches the gullet when the endoscope has been inserted to a certain extent. Since the gullet is positioned near the heart and almost always makes a motion due to the heartbeat, it is difficult to appropriately perform the blur correction process. Therefore, when the region detection section 163 included in the state detection section 160 has determined that the observed region is the gullet, the extraction section 170 decreases the degree of position offset correction (basically disables the correction process).

When the user has found an area that draws attention when the end of the scope passes through the gullet, it is necessary to present a stationary image to the user. In this case, it is considered that the user stops the insertion operation or the dial operation in order to closely observe the area. In this case, it is desirable to enable the blur correction process when the user has not performed an operation for a given time in the same manner as in the case of using the lower gastrointestinal endoscope. However, since the gullet is positioned near the heart and makes a large motion, it is difficult to perform an effective blur correction process. In this case, the extraction section 170 decreases the degree of position offset correction. The minor blur correction process is implemented as described above.

Note that the region detection section 163 included in the state detection section 160 detects the observed region. For example, the region detection section 163 performs a recognition process that detects a given region from an image that has been acquired by the image acquisition section 120 and stored in the buffer 140. The region where the end of the scope is positioned may be determined by measuring the insertion length of the scope, and comparing the insertion length and the normal length of each region. Alternatively, a transmitter may be provided at the end of the scope, and a receiver may be attached to the body surface to determine the position of the end of the scope inside the body. In this case, the organ where the end of the scope is positioned is determined using a normal organ map.

The end of the scope reaches the stomach when the endoscope has been further inserted. The region detection section 163 determines whether or not the end of the scope has reached the stomach. The blur correction process is unnecessary when the end of the scope advances. Therefore, the extraction section 170 disables the blur correction process simultaneously with the scope insertion operation or the dial operation performed by the user.

When the end of the scope has reached the stomach, the user searches an attention area (e.g., lesion) that may be present on the wall surface of the stomach. In this case, it is considered that the user changes the observation angle by performing the dial operation using the operation section 130. Since the user does not observe a given range, and the viewpoint changes to a large extent during the search operation, the blur correction process is not performed. Therefore, the extraction section 170 disables the blur correction process simultaneously with the dial operation.

When the user has found an area that draws attention on the wall surface of the stomach as a result of the search operation, the user performs a zoom operation (zoom operation at a magnification lower than a given threshold value) in order to magnify and closely observe the area. Since it is necessary to present an image with a reduced blur when the user performs close observation, the extraction section 170 enables the blur correction process simultaneously with the zoom operation.

A zoom (magnified) image can be acquired by moving a zoom lens S13 and the imaging element S09 forward (toward the end of the scope) to magnify light focused by the condenser lens S08. Alternatively, a zoom (magnified) image may be acquired by performing an image zoom process (digital zoom process) on the image acquired by the image acquisition section 120. In either case, the magnification acquisition section 165 acquires the magnification information, and transmits the magnification information to the extraction section 170 as the operation state information.

The user optionally takes appropriate measures (e.g., removal) against the found lesion. In this case, the user takes measures using a treatment tool (e.g., forceps) provided at the end of the scope. It is desirable to present a blurless image when the user takes measures using the treatment tool. However, since the motion of the object and the motion of the treatment tool are not synchronized, and the treatment tool is blurred if the blur correction process is performed based on the object, the blur correction process is not performed.

Specifically, the user inserts the procedure tool into an insertion opening S11, moves the procedure tool through a guide tube S12, and sticks the procedure tool out from the guide tube S12 to take measures against the lesion. The state detection section 160 acquires information about insertion of the procedure tool. For example, a sensor (not shown) may be provided at the end of the guide tube S12, and whether or not the procedure tool sticks out from the guide tube S12 may be monitored. Alternatively, whether or not the procedure tool sticks out from the guide tube S12 may be determined by comparing the length of the guide tube S12 with the insertion length of the procedure tool. When the procedure tool sticks out from the guide tube S12, the extraction section 170 extracts the extracted image without taking account of position offset correction.

According to several embodiments of the invention, the image processing device includes the image acquisition section 120 that successively acquires reference image that are successively captured by the imaging section 13 of the endoscope apparatus, the state detection section 160 that detects the operation state of the endoscope apparatus, and acquires the operation state information that indicates the detection result, and the extraction section 170 that extracts the extraction area from the reference image to acquire an extracted image (see FIG. 1). The extraction section 170 determines the degree of position offset correction on an image of the observation target based on the operation state information, and extracts the extracted image from the reference image using an extraction method corresponding to the determined degree of position offset correction.

The operation state information is acquired by detecting state information about the endoscope apparatus. The state information refers to information that is detected when the endoscope apparatus has been operated, for example. The expression “the endoscope apparatus has been operated” is not limited to a case where the scope of the endoscope apparatus has been operated, but includes a case where the entire endoscope apparatus has been operated. Therefore, the operation state information may include detection of an attention area based on the operation state (screening) of the endoscope apparatus.

This makes it possible to acquire the operation state information, and determine the degree of position offset correction based on the acquired operation state information. The extracted image is extracted using an extraction method corresponding to the determined degree of position offset correction. This makes it possible to perform an appropriate position offset correction process corresponding to the operation state. Note that the advantages obtained by performing the reduced position offset correction process have been described above.

The extraction section 170 may determine the degree of position offset correction based on the operation state information, and may determine the position of the extraction area within the reference image based on the determined degree of position offset correction.

This makes it possible to utilize the extraction method that changes the position of the extraction area within the reference image as the extraction method corresponding to the degree of position offset correction. As shown in FIG. 9, the position of the area A3 that is intermediate between the area A1 when the position offset correction process is not performed and the area A2 when the position offset correction process is performed to a maximum extent is changed. In the example shown in FIG. 9, the area A3 becomes closer to the area A1 as the degree of position offset correction decreases, and becomes closer to the area A2 as the degree of position offset correction increases.

The state detection section 160 acquires information as to whether or not the scope of the endoscope apparatus is stationary as the operation state information, and the extraction section 170 increases the degree of position offset correction when it has been determined that the scope of the endoscope apparatus is stationary based on the operation state information. For example, the scope of the endoscope apparatus is determined to be stationary when it has been detected that the operation section of the endoscope apparatus has not been operated for a given period.

The expression “increases the degree of position offset correction” means that the degree of position offset correction is increased as compared with the case where it has been determined that the scope of the endoscope apparatus is not stationary. An increase in the degree of position offset correction may refer to an absolute change (increase) in the degree of position offset correction (i.e., the degree of position offset correction is increased as compared with a given reference value) or a relative change (increase) in the degree of position offset correction (i.e., the degree of position offset correction is increased as compared with the degree of position offset correction at the preceding time (timing)). Likewise, a decrease in the degree of position offset correction may refer to an absolute change (decrease) in the degree of position offset correction or a relative change (decrease) in the degree of position offset correction. The expression “increases the degree of position offset correction” includes the case where the position offset correction function (process) is enabled. Likewise, the expression “decreases the degree of position offset correction” includes the case where the position offset correction function (process) is disabled.

This makes it possible to increase the degree of position offset correction when it has been determined that the scope of the endoscope apparatus is stationary. Since the position of the attention area within the acquired reference image does not change to a large extent when the scope of the endoscope apparatus is stationary, it is considered that no problem occurs even if the degree of position offset correction is increased. It is considered that the doctor aims to closely observe a specific area when the scope of the endoscope apparatus is stationary. Therefore, it is desirable to provide a moving image with a reduced blur by increasing the degree of position offset correction.

The state detection section 160 acquires information as to whether or not the scope of the endoscope apparatus moves closer to the observation target as the operation state information, and the extraction section 170 increases the degree of position offset correction when it has been determined that the scope of the endoscope apparatus moves closer to the observation target based on the operation state information. For example, the edge shape of the observation target may be extracted by subjecting the reference image to a Laplacian filter process or the like, and whether or not the scope of the endoscope apparatus moves closer to the observation target may be determined based on a change in the size of the edge shape. Alternatively, a plurality of local areas is set within the reference image, and whether or not the scope of the endoscope apparatus moves closer to the observation target may be determined based on a change in distance information about the distance between the local areas. The distance information may be distance information about the distance between reference positions (e.g., center position coordinate information) that are respectively set to the local areas.

The expression “increases the degree of position offset correction” means that the degree of position offset correction is increased as compared with the case where it has been determined that the scope of the endoscope apparatus does not move closer to the observation target.

This makes it possible to increase the degree of position offset correction when it has been determined that the scope of the endoscope apparatus moves closer to the observation target. It is considered that the user aims to magnify and closely observe the observation target when the scope of the endoscope apparatus moves closer to the observation target. It is possible to provide a moving image with a reduced blur by increasing the degree of position offset correction. Whether or not the scope of the endoscope apparatus moves closer to the observation target may be determined by an arbitrary method. For example, it is determined that the scope of the endoscope apparatus moves closer to the observation target when the size of the edge shape of the object has increased, or when the distance between a plurality of local areas has increased.

The state detection section 160 may acquire information as to whether or not an attention area has been detected within the reference image as the operation state information, and the extraction section 170 increases the degree of position offset correction when it has been determined that the attention area has been detected within the reference image based on the operation state information.

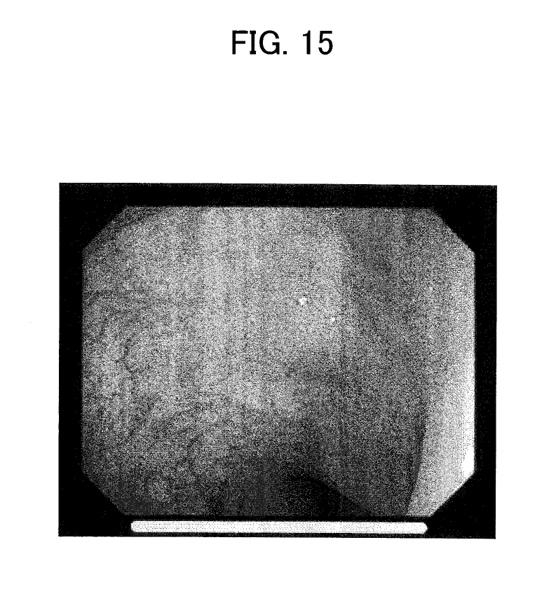

The expression “increases the degree of position offset correction” means that the degree of position offset correction is increased as compared with the case where it has been determined that the attention area has not been detected within the reference image. The term “attention area” refers to an area for which the observation priority is higher than that of other areas. For example, when the user is a doctor, and desires to perform treatment, the attention area refers to an area that includes a mucosal area or a lesion area. If the doctor desires to observe bubbles or feces, the attention area refers to an area that includes a bubble area or a feces area. Specifically, the attention area for the user differs depending on the objective of observation, but necessarily has an observation priority higher than that of other areas. When the system automatically detects the attention area, the system may notify the user that the attention area has been detected (see FIG. 15). In the example shown in FIG. 15, a line of a specific color is displayed in the lower area of the screen.

This makes it possible to increase the degree of position offset correction when the attention area has been detected within the reference image. Since the attention area is an area for which the observation priority is higher than that of other areas, it is considered that the user closely observes the attention area when the attention area has been detected. Therefore, a moving image with a reduced blur is provided by increasing the degree of position offset correction.

The state detection section 160 may acquire information about a region where the scope of the endoscope apparatus is positioned as the operation state information, and the extraction section 170 may decrease the degree of position offset correction even if the attention area has been detected when it has been determined that the scope of the endoscope apparatus is positioned in a given region based on the operation state information.

The expression “decreases the degree of position offset correction” means that the degree of position offset correction is decreased as compared with the case where it has been determined that the scope of the endoscope apparatus is not positioned in the given region.

This makes it possible to decrease the degree of position offset correction even if the attention area has been detected when the given region is observed. The given region may be a gullet or the like. For example, since the gullet is positioned near the heart, the gullet is significantly affected by the heartbeat. Therefore, the object may make a large motion when the gullet is observed, so that the blur correction process may not properly function even if the degree of position offset correction is increased. Accordingly, the degree of position offset correction is decreased when the gullet or the like is observed.

The state detection section 160 may detect the region where the scope of the endoscope apparatus is positioned based on the feature quantity of the pixels of the reference image. The state detection section 160 may detect the region where the scope of the endoscope apparatus is positioned by comparing an insertion length with a reference length, the insertion length indicating the length of an area of the scope that has been inserted into the body of the subject.

The relationship between the insertion length and the position of the region is indicated by the reference length. For example, the normal length of the organ determined taking account of the sex and the age of the subject may be used as the reference length. The region can be determined by comparing the insertion length with the reference length by storing specific information (e.g., descending colon: L1 to L2 cm from the insertion start point (e.g., anus), transverse colon: L2 to L3 cm from the insertion start point) as the reference length. For example, when the insertion length is L4 (L2<L4<L3), it is determined that the scope is positioned in the transverse colon.

This makes it possible to determine the region where the scope is positioned by image processing or based on a comparison between the insertion length and the reference length.

The state detection section 160 may acquire information as to whether or not the imaging section 13 is set to a magnifying observation state as the operation state information, and the extraction section 170 may decrease the degree of position offset correction when it has been determined that the imaging section 13 is set to the magnifying observation state based on the operation state information.

The expression “decreases the degree of position offset correction” means that the degree of position offset correction is decreased as compared with the case where it has been determined that the imaging section 13 is not set to the magnifying observation state.

This makes it possible to decrease the degree of position offset correction when it has been determined that the imaging section 13 is set to the magnifying observation state. For example, the object is observed at a magnification equal to or higher than 100 during magnifying observation using an endoscope. Therefore, the range of the object acquired as the reference image is very narrow, and the position of the object within the image changes to a large extent even if the amount of blur is small. Accordingly, the degree of position offset correction is decreased since it is considered that the blur correction process is not effective.

The state detection section 160 may acquire information about the zoom magnification of the imaging section 13 of the endoscope apparatus that is set to the magnifying observation state as the operation state information, and the extraction section 170 may increase the degree of position offset correction when the zoom magnification is smaller than a given threshold value, and may decrease the degree of position offset correction as the zoom magnification increases when the zoom magnification is larger than the given threshold value. Note that the degree of position offset correction is smaller than a reference degree of position offset correction.

The reference degree of position offset correction refers to the degree of position offset correction that is used as the absolute reference of the degree of position offset correction. The reference degree of position offset correction corresponds to the degree of position offset correction indicated by a dotted line in FIG. 6.

This makes it possible to control the degree of position offset correction as shown in FIG. 6. It is considered that the user aims to closely observe a specific area when the user increases the zoom magnification. Therefore, the degree of position offset correction is basically increased. This is the same as in the case where the user moves the scope closer to the observation target. Therefore, the degree of position offset correction is increased as the zoom magnification increases to a certain extent (i.e., within a range equal to or smaller than a given threshold value). However, the position of the object within the image changes to a large extent even if the amount of blur is small as the magnification increases. In this case, it is considered that the blur correction process is not effective even if the degree of position offset correction is increased. Therefore, the degree of position offset correction is decreased as the zoom magnification further increases (i.e., the effect of a blur increases).

The state detection section 160 may acquire information about the operation amount of the dial of the endoscope apparatus that has been operated by the user as the operation state information, and the extraction section 170 may decrease the degree of position offset correction when the operation amount of the dial is larger than a given reference operation amount.

The expression “decreases the degree of position offset correction” means that the degree of position offset correction is decreased as compared with the case where it has been determined that the operation amount of the dial is not larger than the reference operation amount.

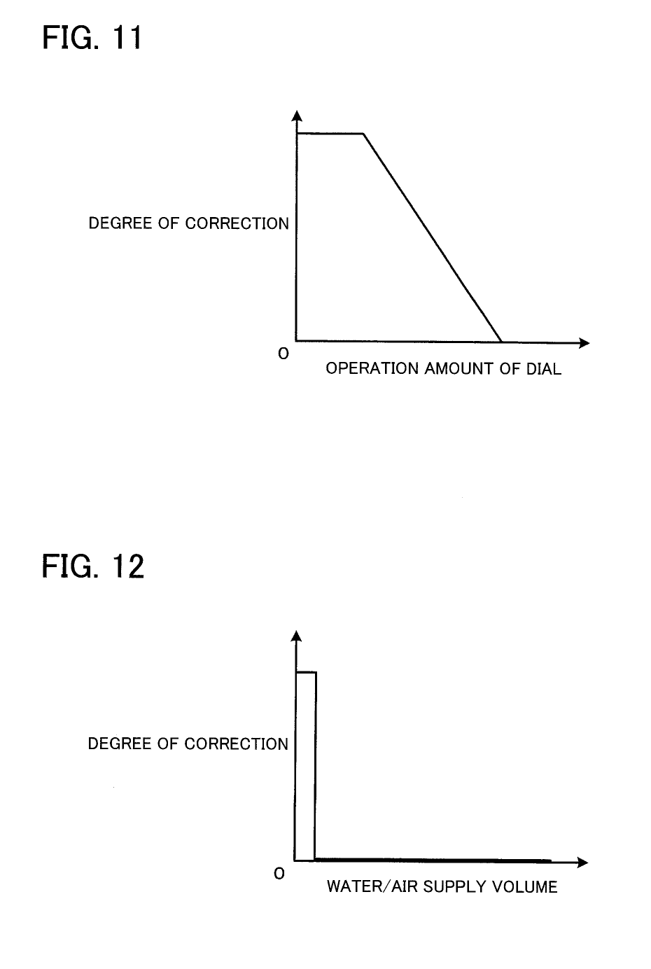

This makes it possible to decrease the degree of position offset correction when the operation amount of the dial is large (see FIG. 11). For example, the operation amount of the dial corresponds to the moving amount of the end of the scope of the endoscope apparatus. Therefore, the scope is moved to a large extent when the operation amount of the dial is large. In this case, it is considered that the user performs a screening operation or the like instead of observing a specific area. Therefore, the degree of position offset correction is decreased.

The state detection section 160 may acquire information about the air supply volume when the endoscope apparatus supplies air, or the water supply volume when the endoscope apparatus supplies water, as the operation state information, and the extraction section 170 may decrease the degree of position offset correction when the air supply volume or the water supply volume is larger than a given threshold value.

The expression “decreases the degree of position offset correction” means that the degree of position offset correction is decreased as compared with the case where it has been determined that the air supply volume or the water supply volume is not larger than the given threshold value.

This makes it possible to decrease the degree of position offset correction when the air supply volume or the water supply volume is large (see FIG. 12). When the air supply volume or the water supply volume is not larger than the given threshold value, it is considered that the user merely aims to perform the air supply operation or the water supply operation, and does not aim to observe the object. Moreover, it is difficult to observe the observation target when water flows due to the water supply operation. Therefore, the degree of position offset correction is decreased since it is considered that the position offset correction process is not effective.

The image processing device may include a position offset correction target area detection section that detects a position offset correction target area from the reference image based on the pixel value of the pixel within the reference image, the position offset correction target area being an area that includes an image of an identical observation target, and the extraction section 170 may change the position of the extraction area corresponding to the position of the position offset correction target area. Specifically, the extraction section 170 may change the position of the extraction area so that the position offset correction target area is located at a given position within the extraction area.

This makes it possible to utilize the method that changes the position of the extraction area corresponding to the position offset correction target area as the extraction method corresponding to the degree of position offset correction. Specifically, the extraction section 170 may change the position of the extraction area so that the position offset correction target area is located at a given position (e.g., center position) within the extraction area.

The extraction section 170 sets an area located at an intermediate position between a first extraction area position and a second extraction area position as the extraction area when decreasing the degree of position offset correction, the first extraction area position being the position of the extraction area when the position offset correction process is not performed, and the second extraction area position being the position of the extraction area when the position offset correction process is performed to a maximum extent (i.e., a position offset of the observation target does not occur within the extracted image).

The positional relationship between the area corresponding to the first extraction area position, the area corresponding to the second extraction area position, and the extraction area is determined based on the positional relationship between reference positions set to the respective areas. The reference position refers to position information set corresponding to the area. For example, the reference position refers to coordinate information about the center position of the area, coordinate information about the lower left end of the area, or the like. Specifically, the extraction area is located at an intermediate position between the first extraction area position and the second extraction area position when the reference position of the extraction area is located between the reference position of the area corresponding to the first extraction area position and the reference position of the area corresponding to the second extraction area position.

This makes it possible to implement the reduced position offset correction process (see FIG. 9). A specific method that implements the reduced position offset correction process, the advantages obtained by the reduced position offset correction process, and the like have been described above.

The image processing device may include the display control section 180. The display control section 180 may perform a control process that successively displays the extracted images extracted by the extraction section 170, or may perform a control process that successively displays degree-of-correction information that indicates the degree of position offset correction.

This makes it possible to display the extracted image extracted by the extraction section 170, and display the information about the degree of position offset correction used when acquiring the extracted image.

Several embodiments of the invention relate to an endoscope apparatus that includes the image processing device and an endoscopy scope.

This makes it possible to achieve the above effects by applying the methods according to several embodiments of the invention to an endoscope apparatus instead of an image processing device.

Several embodiments of the invention relate to a method of controlling an image processing device, the method including: successively acquiring reference image that are successively captured by the imaging section 13; detecting the operation state of the endoscope apparatus, and acquiring the operation state information that indicates the detection result; and extracting an area including an image of the observation target from the reference image as the extraction area, determining the degree of position offset correction on the image of the observation target based on the operation state information when acquiring an extracted image, and extracting the extracted image from the reference image using an extraction method corresponding to the determined degree of position offset correction.

This makes it possible to achieve the above effects by applying the methods according to several embodiments of the invention to a method of controlling an image processing device instead of an image processing device.

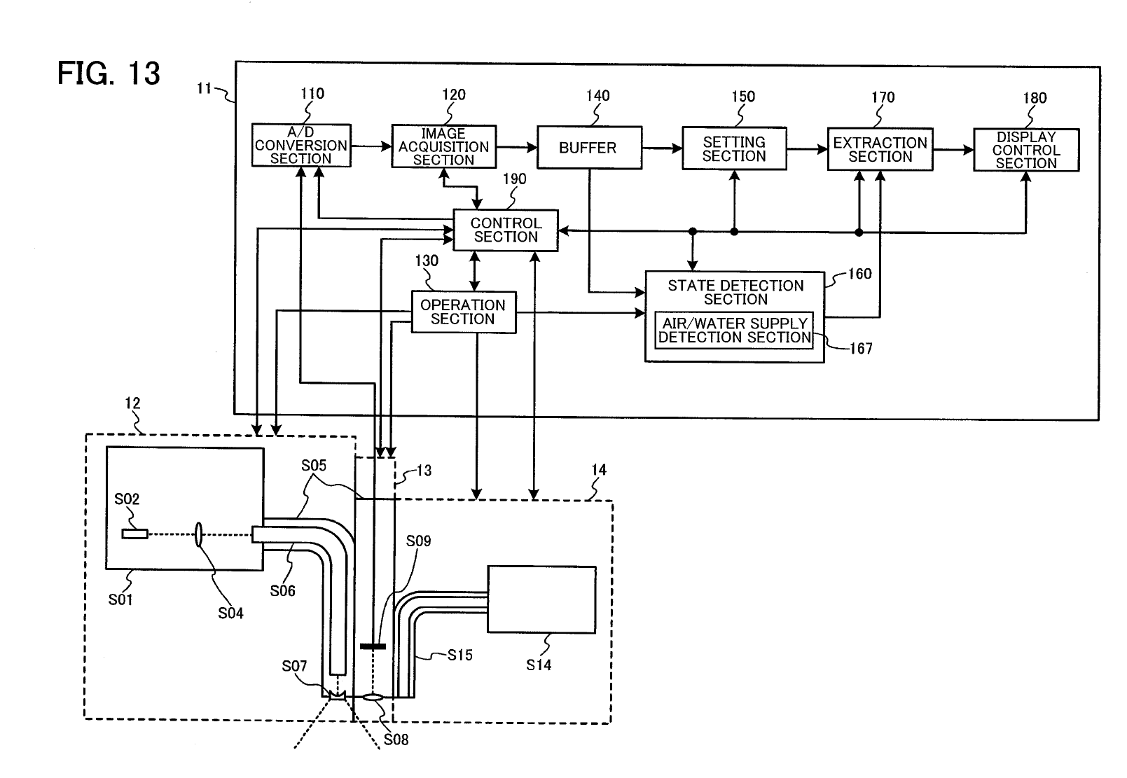

Several embodiments of the invention relate to an image processing device that includes the image acquisition section 120, a setting section 150, the state detection section 160, and the extraction section 170 (see FIG. 13). The image acquisition section 120 successively acquires reference image. The setting section 150 sets a first extraction mode and a second extraction mode when extracting an extracted image from each reference image. The state detection section 160 acquires the operation state information. The extraction section 170 selects the first extraction mode or the second extraction mode based on the operation state information, and performs an extraction process using an extraction method corresponding to the selected mode. The state detection section 160 acquires information as to whether or not the scope of the endoscope apparatus is used to supply air or water as the operation state information, and the extraction section 170 selects the second extraction mode when it has been determined that the scope of the endoscope apparatus is used to supply air or water. For example, whether or not the scope of the endoscope apparatus is used to supply air or water may be determined by detecting whether or not an air supply instruction or a water supply instruction has been issued using the operation section of the endoscope apparatus.

The first extraction mode is an extraction mode in which a position offset of the image of the observation target is corrected, and the second extraction mode is an extraction mode in which a position offset of the image of the observation target is not corrected.

This makes it possible to set the first extraction mode corresponding to a state in which the position offset correction process is enabled and the second extraction mode corresponding to a state in which the position offset correction process is disabled, and select an appropriate extraction mode based on the information about the air supply process or the water supply process. Specifically, the second extraction mode corresponding to a state in which the position offset correction process is disabled is selected when the air supply process or the water supply process is performed. The second extraction mode is selected for the same reason as that when decreasing the degree of position offset correction when the air supply process or the water supply process is performed.

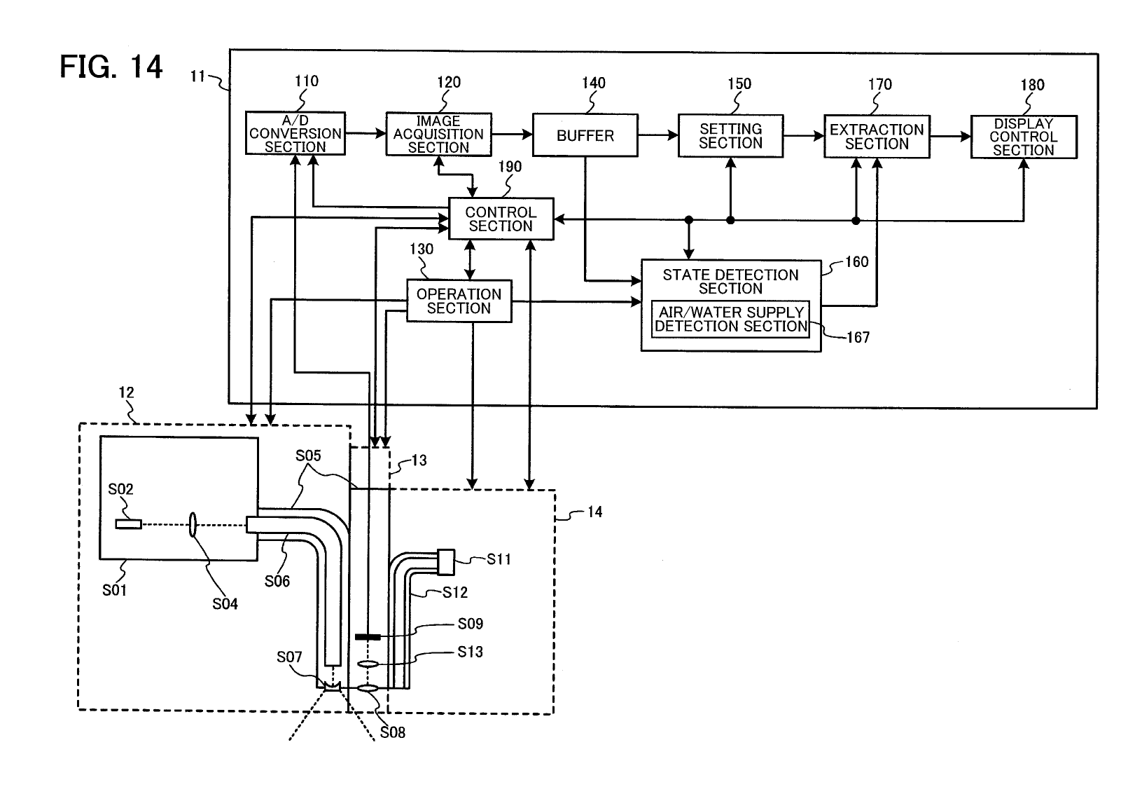

Several embodiments of the invention relate to an image processing device that includes the image acquisition section 120, the setting section 150, the state detection section 160, and the extraction section 170 (see FIG. 14). The image acquisition section 120 successively acquires reference image. The setting section 150 sets the first extraction mode and the second extraction mode when extracting an extracted image from each reference image. The state detection section 160 acquires the operation state information. The extraction section 170 selects the first extraction mode or the second extraction mode based on the operation state information, and performs an extraction process using an extraction method corresponding to the selected mode. The state detection section 160 acquires information as to whether or not the scope of the endoscope apparatus is used to treat the observation target as the operation state information, and the extraction section 170 selects the second extraction mode when it has been determined that the scope of the endoscope apparatus is used to treat the observation target. For example, whether or not the scope of the endoscope apparatus is used to treat the observation target may be determined based on the sensor information from a sensor provided at the end of the scope.

The first extraction mode is an extraction mode in which a position offset of the image of the observation target is corrected, and the second extraction mode is an extraction mode in which a position offset of the image of the observation target is not corrected.

This makes it possible to set the first extraction mode corresponding to a state in which the position offset correction process is enabled and the second extraction mode corresponding to a state in which the position offset correction process is disabled, and select an appropriate extraction mode based on whether or not the scope is used to treat the observation target. Specifically, the second extraction mode corresponding to a state in which the position offset correction process is disabled is selected when the scope is used to treat the observation target. This is because a position offset of a treatment tool used to treat the observation target is not synchronized with a position offset of the observation target. Specifically, the user performs treatment using the treatment tool that sticks out from the end of the scope, and the treatment tool is displayed within the acquired reference image. However, since the motion of the observation target and the motion of the treatment tool are not synchronized, it is difficult to perform the position offset correction process so that both the observation target and the treatment tool are not blurred. Therefore, the second extraction mode in which the position offset correction process is disabled is selected when treating the observation target. Whether or not the user treats the observation target may be determined by determining whether or not the treatment tool sticks out from the end of the scope. Specifically, a sensor that detects whether or not the treatment tool sticks out from the end of the scope is provided, and whether or not the user treats the observation target is determined based on sensor information from the sensor.

The extraction method corresponding to the second extraction mode sets the extraction area without taking account of position offset correction on the observation target. The extraction section 170 extracts the image included in the set extraction area as the extracted image. The extraction method corresponding to the second extraction mode may set the extraction area at a predetermined position within the reference image without taking account of position offset correction on the observation target.

This makes it possible to utilize a method that sets the extraction area without taking account of position offset correction as the extraction method corresponding to the second extraction mode. In particular, the extraction area may be set at a predetermined position within the reference image. This makes it possible to easily determine the extraction area, and simplify the process.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term cited with a different term having a broader meaning or the same meaning at least once in the specification and the drawings can be replaced by the different term in any place in the specification and the drawings. The configuration and the operation of the image processing device are not limited to those described in connection with the embodiments. Various modifications and variations may be made.

What is claimed is:

1. An image processing device comprising:
an image acquisition section that successively acquires a reference image via a successive imaging process performed by an imaging section of an endoscope apparatus, the reference image being an image including an image of an observation target;
a state detection section that detects an operation state of the endoscope apparatus, and acquires operation state information that indicates a detection result; and
an extraction section that extracts an area including the image of the observation target from the acquired reference image as an extraction area to acquire an extracted image,
the extraction section determining a degree of position offset correction on the image of the observation target based on the operation state information acquired by the state detection section, and extracting the extracted image from the reference image using an extraction method corresponding to the determined degree of position offset correction.

2. The image processing device as defined in claim 1,
the extraction section determining the degree of position offset correction on the image of the observation target based on the operation state information acquired by the state detection section, and setting a position of the extraction area within the reference image based on the determined degree of position offset correction.

3. The image processing device as defined in claim 1,
the state detection section acquiring information as to whether or not a scope of the endoscope apparatus is stationary as the operation state information, and
the extraction section increasing the degree of position offset correction when it has been determined that the scope of the endoscope apparatus is stationary based on the information as to whether or not the scope of the endoscope apparatus is stationary.

4. The image processing device as defined in claim 3,
the state detection section determining that the scope of the endoscope apparatus is stationary when it has been detected that an operation section of the endoscope apparatus has not been operated for a given period based on the acquired operation state information, and
the extraction section increasing the degree of position offset correction when it has been detected that the operation section of the endoscope apparatus has not been operated for the given period, and it has thus been determined that the scope of the endoscope apparatus is stationary.

5. The image processing device as defined in claim 1,
the state detection section acquiring information as to whether or not a scope of the endoscope apparatus moves closer to the observation target as the operation state information, and
the extraction section increasing the degree of position offset correction when it has been determined that the scope of the endoscope apparatus moves closer to the observation target based on the information as to whether or not the scope of the endoscope apparatus moves closer to the observation target.

6. The image processing device as defined in claim 5,
the state detection section detecting a size of an edge shape of the observation target within the reference image, and detecting whether or not the scope of the endoscope apparatus moves closer to the observation target based on a change in the detected size of the edge shape, and
the extraction section increasing the degree of position offset correction when it has been determined that the scope of the endoscope apparatus moves closer to the observation target based on the change in the size of the edge shape.

7. The image processing device as defined in claim 5,
the state detection section setting a plurality of local areas within the reference image, setting a reference position to each of the plurality of local areas, and detecting whether or not the scope of the endoscope apparatus moves closer to the observation target based on a change in distance information about a distance between the reference positions, and
the extraction section increasing the degree of position offset correction when it has been determined that the scope of the endoscope apparatus moves closer to the observation target based on the change in the distance information.

8. The image processing device as defined in claim 1,
the state detection section acquiring information as to whether or not an attention area has been detected within the reference image as the operation state information, and
the extraction section increasing the degree of position offset correction when it has been determined that the attention area has been detected based on the information as to whether or not the attention area has been detected.

9. The image processing device as defined in claim 8,
the state detection section further acquiring information about a region where a scope of the endoscope apparatus that is being operated is positioned, and
the extraction section decreasing the degree of position offset correction even though the attention area has been detected when it has been determined that the region is a given region based on the information about the region where the scope of the endoscope apparatus is positioned.

10. The image processing device as defined in claim 9,
the state detection section detecting the region where the scope of the endoscope apparatus that is being operated is positioned based on a feature quantity of a pixel of the reference image, and
the extraction section decreasing the degree of position offset correction even though the attention area has been detected when it has been determined that the region is the given region based on the feature quantity of the pixel of the reference image.

11. The image processing device as defined in claim 9,
the state detection section detecting an insertion length that indicates a length of an area of the scope that has been inserted into a body of a subject, and detecting the region where the scope of the endoscope apparatus that is being operated is positioned, by comparing the insertion length with a reference length that indicates a relationship between the insertion length and a position of the region, and
the extraction section decreasing the degree of position offset correction even though the attention area has been detected when it has been determined that the region is the given region as a result of comparing the insertion length with the reference length.

12. The image processing device as defined in claim 1,
the state detection section acquiring information as to whether or not the imaging section is set to a magnifying observation state as the operation state information, and
the extraction section decreasing the degree of position offset correction when it has been determined that the imaging section is set to the magnifying observation state based on the information as to whether or not the imaging section is set to the magnifying observation state.

13. The image processing device as defined in claim 1,
the state detection section acquiring information about a zoom magnification of the imaging section of the endoscope apparatus that is set to a magnifying observation state as the operation state information, and
the extraction section increasing the degree of position offset correction as the zoom magnification increases while the degree of position offset correction to be smaller than a reference degree of position offset correction when the zoom magnification is smaller than a given threshold value.

14. The image processing device as defined in claim 1,
the state detection section acquiring information about a zoom magnification of the imaging section of the endoscope apparatus that is set to a magnifying observation state as the operation state information, and
the extraction section decreasing the degree of position offset correction as the zoom magnification increases while setting the degree of position offset correction to be smaller than a reference degree of position offset correction when the zoom magnification is larger than a given threshold value.

15. The image processing device as defined in claim 1,
the state detection section acquiring information about an operation amount of a dial of the endoscope apparatus that has been operated by a user as the operation state information, and
the extraction section decreasing the degree of position offset correction when the operation amount of the dial is larger than a given reference operation amount.

16. The image processing device as defined in claim 1,
the state detection section acquiring information about an air supply volume when the endoscope apparatus supplies air, or a water supply volume when the endoscope apparatus supplies water, as the operation state information, and
the extraction section decreasing the degree of position offset correction when the air supply volume or the water supply volume is larger than a given threshold value.

17. The image processing device as defined in claim 1, further comprising:
a position offset correction target area detection section that detects a position offset correction target area from the reference image based on a pixel value of a pixel within the reference image, the position offset correction target area being an area that includes the image of the observation target, and
the extraction section changing a position of the extraction area corresponding to a position of the position offset correction target area detected within the reference image.

18. The image processing device as defined in claim 17,
the extraction section changing the position of the extraction area based on the position of the position offset correction target area detected within the reference image so that the position offset correction target area is located at a specific position within the extraction area.

19. The image processing device as defined in claim 1,
the extraction section setting an area located at an intermediate position between a first extraction area position and a second extraction area position as the extraction area when decreasing the degree of position offset correction on the image of the observation target, the first extraction area position being a position of the extraction area when the position offset correction is not performed on the observation target, and the second extraction area position being a position of the extraction area when the extracted image without a position offset of the observation target has been extracted.

20. The image processing device as defined in claim 1, further comprising:
a display control section that performs a control process that successively displays the extracted image extracted by the extraction section.

21. The image processing device as defined in claim 1, further comprising:
a display control section that performs a control process that successively displays degree-of-correction information that indicates the determined degree of position offset correction.

22. An endoscope apparatus comprising:
the image processing device as defined in claim 1; and
an endoscopy scope.

23. A method of controlling an image processing device, the method comprising:
successively acquiring a reference image via a successive imaging process performed by an imaging section of an endoscope apparatus, the reference image being an image including an image of an observation target;
detecting an operation state of the endoscope apparatus, and acquiring operation state information that indicates a detection result;
determining a degree of position offset correction on the image of the observation target based on the acquired operation state information when extracting an area including the image of the observation target from the acquired reference image as an extraction area and acquiring an extracted image; and
extracting the extracted image from the reference image using an extraction method corresponding to the determined degree of position offset correction.

24. An image processing device comprising:
an image acquisition section that successively acquires a reference image via a successive imaging process performed by an imaging section of an endoscope apparatus, the reference image being an image including an image of an observation target;
a setting section that sets a first extraction mode and a second extraction mode when extracting an image including the image of the observation target from the acquired reference image as an extracted image, the first extraction mode being an extraction mode in which a position offset of the image of the observation target included in the extracted image is corrected, and the second extraction mode being an extraction mode in which a position offset of the image of the observation target is not corrected;
a state detection section that detects an operation state of the endoscope apparatus, and acquires operation state information that indicates a detection result; and
an extraction section that selects the first extraction mode or the second extraction mode based on the acquired operation state information, and extracts the extracted image from the reference image using an extraction method corresponding to the selected extraction mode,
the state detection section acquiring information as to whether or not a scope of the endoscope apparatus is used to supply air or water as the operation state information, and
the extraction section selecting the second extraction mode when it has been determined that the scope of the endoscope apparatus is used to supply air or water based on the acquired operation state information.

25. The image processing device as defined in claim 24,
the state detection section detecting whether or not the scope of the endoscope apparatus is used to supply air or water by detecting whether or not an air supply instruction or a water supply instruction has been issued using an operation section of the endoscope apparatus.

26. An image processing device comprising:
an image acquisition section that successively acquires a reference image via a successive imaging process performed by an imaging section of an endoscope apparatus, the reference image being an image including an image of an observation target;
a setting section that sets a first extraction mode and a second extraction mode when extracting an image including the image of the observation target within the reference image from the acquired reference image as an extracted image, the first extraction mode being an extraction mode in which a position offset of the image of the observation target included in the extracted image is corrected, and the second extraction mode being an extraction mode in which a position offset of the image of the observation target is not corrected;
a state detection section that detects an operation state of the endoscope apparatus, and acquires operation state information that indicates a detection result; and
an extraction section that selects the first extraction mode or the second extraction mode based on the acquired operation state information, and extracts the extracted image from the reference image using an extraction method corresponding to the selected extraction mode,
the state detection section acquiring information as to whether or not a scope of the endoscope apparatus is used to treat the observation target as the operation state information, and
the extraction section selecting the second extraction mode when it has been determined that the scope of the endoscope apparatus is used to treat the observation target based on the acquired operation state information.

27. The image processing device as defined in claim 26,
the state detection section detecting whether or not the scope of the endoscope apparatus is used to treat the observation target based on sensor information from a sensor provided at an end of the scope of the endoscope apparatus.

28. The image processing device as defined in claim 26,
the extraction method corresponding to the second extraction mode setting an extraction area for extracting the extracted image within the reference image without taking account of position offset correction on the observation target, and
the extraction section extracting an image included in the extraction area set within the reference image as the extracted image.

29. The image processing device as defined in claim 28,
the extraction method corresponding to the second extraction mode setting the extraction area at a predetermined position within the reference image without taking account of position offset correction on the observation target.
